(19) United States
(12) Patent Application Publication
(10) Pub. No.: US 2014/0120450 A1
(43) Pub. Date: May 1, 2014

(54) SOLID OXIDE FUEL CELL MODULE

(71) Applicant: SAMSUNG ELECTRO-MECHANICS CO., LTD., Suwon (KR)

(72) Inventors: Jai Hyoung Gil, Suwon (KR); Bon Seok Koo, Suwon (KR)

(73) Assignee: SAMSUNG ELECTRO-MECHANICS CO., LTD., Suwon (KR)

(21) Appl. No.: 13/770,124

(22) Filed: Feb. 19, 2013

(30) Foreign Application Priority Data
Oct. 26, 2012 (KR) 10-2012-0119656

(51) Int. Cl. H01M 8/02

(52) U.S. Cl. CPC H01M 8/0202
USPC 429/469

(57) ABSTRACT

Disclosed herein is a solid oxide fuel cell module including: a plurality of cylindrical unit cells including a cylindrical internal electrode, an electrolyte, and an external electrode; stack supports including a pair of current collecting plates arranged in parallel and elastic parts changing a gap between the pair of current collecting plates, wherein the stack supports are arranged so as to be in electrical communication with the external electrode of the unit cell.

### CROSS REFERENCE TO RELATED APPLICATION

This application claims the benefit of Korean Patent Application No. 10-2012-0119656, filed on Oct. 26, 2012, entitled “Solid Oxide Fuel Cell Module”, which is hereby incorporated by reference in its entirety into this application.

### BACKGROUND OF THE INVENTION

1. Technical Field

The present invention relates to a solid oxide fuel cell module.

2. Description of the Related Art

Generally, a fuel cell is a device directly converting chemical energy of fuel (hydrogen, liquefied natural gas (LNG), liquefied petroleum gas (LPG), or the like) and oxygen (air) into electrical and thermal energy by an electrochemical reaction. The existing power generation technologies should perform processes such as fuel combustion, steam generation, turbine driving, power generator driving, or the like, while the fuel cell does not need to perform processes such as fuel combustion, turbine driving, or the like. As a result, the fuel cell is a new power generation technology capable of increasing power generation efficiency without causing environmental problems. This fuel cell minimally discharges air pollutants such as SOₓ, NOₓ, or the like, and generates less carbon dioxide, such that chemical-free, low-noise, non-vibration power generation, or the like, may be implemented.

There are various types of fuel cells such as a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC), or the like. Among them, the solid oxide fuel cell (SOFC) depends on activation polarization, which lowers over-voltage and irreversible loss to increase power generation efficiency. Further, since the reaction rate in electrodes is rapid, the SOFC does not need to use expensive precious metals as an electrode catalyst. Therefore, the solid oxide fuel cell is an essential power generation technology in order to enter a hydrogen economy society in the future.

In the SOFC as described above, unlike the existing polymer electrolyte membrane fuel cell (PEMFC), since any one of carbon- or hydrocarbon-based fuel may be used in the solid oxide fuel cell, there is an advantage in that a degree of freedom in selecting the fuel is high. Chemical equations in the case in which hydrogen (H₂) is used as fuel are as follows.

Anode reaction: H₂(g)+O²⁻→H₂O(g)+2e⁻

CO(g)+O²⁻→CO₂(g)+2e⁻

Cathode reaction: O₂(g)+4e⁻→2O²⁻

Overall reaction: O₂+H₂+CO→H₂O+CO₂

As a method of collecting current by connecting unit cells of a cylindrical fuel cell to each other in the art or using an external electrode, a wire winding method of winding the outside of the electrode with a high conductive wire to collect the current and extending this current collecting wire to connect unit cells to each other, a method of collecting the current using a foam structure, and the like, are representative.

For example, a method of winding the outside of the electrode in order to collect current was disclosed in Korean Patent Laid-Open Publication No. 10-2011-0085848 (Patent Document 1). In this method, since a length of a wire collecting current is also increased according to the size of the unit cell, resistance is also increased corresponding thereto. Finally, performance of the unit cell may be reduced due to an increase in current collecting resistance, such that performance of the entire system may be reduced. In addition, in the case of stacking unit cells, since wiring should be performed on each of the unit cells, the entire current collecting system may be significantly complicated.

In addition, in the existing solid oxide fuel cell, a current collection function and a support function of the unit cell is performed through the mesh or foam structure, and particularly, in the case of a solid oxide fuel cell having the foam structure, as widely known, since significant work man-hours should be required in order to form the foam and improve oxidation resistance, manufacturing cost may be increased.

[Prior Art Document]

[Patent Document]

(Patent Document 1) Korean Patent Laid-open Publication No. 10-2011-0085848

### SUMMARY OF THE INVENTION

The present invention has been made in an effort to provide a solid oxide fuel cell module capable of securing stability in a stacked state while improving current collection efficiency.

According to a preferred embodiment of the present invention, there is provided a solid oxide fuel cell module including: a plurality of unit cells including a cylindrical internal electrode, an electrolyte, and an external electrode; stack supports including a pair of current collecting plates arranged in parallel and elastic parts changing a gap between the pair of current collecting plates, wherein the stack supports are arranged so as to be in electrical communication with the external electrode of the unit cell.

Selectively, a metal mesh may be additionally arranged between an outer surface of the unit cell and the stack support, wherein the metal mesh has the same shape as that of the external electrode of the unit cell.

The current collecting plate may include a plurality of through holes formed therein to provide a channel of gas (fuel or air).

The current collecting plate may have a flat plate shape or be curved with the same curvature as that of an outer surface of the unit cell.

The unit cell may include an exposed portion formed by partially removing the external electrode and the electrolyte to allow a portion of the internal electrode to be exposed and further include an interconnector provided on the exposed portion of the internal electrode.

Preferably, the interconnector may protrude outwardly so as to be higher than the outermost portion of the external electrode.

Particularly, the interconnector may be spaced apart from the external electrode by a predetermined interval so as not to be in electric communication with the external electrode.

The stack support may be made of an SUS-based alloy, and oxidation protective coating may be applied thereto.

In the solid oxide fuel cell module, three stack supports arranged in a U shape may be provided therein so as to receive the cylindrical unit cell. That is, the stack supports may be arranged at a lower surface and both sides of the unit cell except for an exposed portion.

Selectively, the unit cell may include a cylindrical anode, and the electrolyte and a cathode sequentially stacked on an outer peripheral surface of the anode, wherein the anode forms the internal electrode, and the cathode forms the external electrode.

Otherwise, the unit cell may include a cylindrical cathode, and the electrolyte and an anode sequentially stacked on an outer peripheral surface of the cathode, wherein the cathode forms the internal electrode, and the anode forms the external electrode.

The solid oxide fuel cell module may be stacked in a housing enclosed by support walls and include a current collector provided at each of the upper and lower support walls.

The housing may further include insulation plates provided at inner sides of the support walls.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view schematically showing a solid oxide fuel cell module according to a preferred embodiment of the present invention;

FIG. 1A is a view schematically showing a solid oxide fuel cell module including a different type stack support;

FIG. 2 is a view showing a state in which the solid oxide fuel cells shown in FIG. 1 are coupled in parallel with each other; and

FIG. 3 is a cross-sectional view of the case in which the solid oxide fuel cell modules according to the preferred embodiment of the present invention are stacked.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

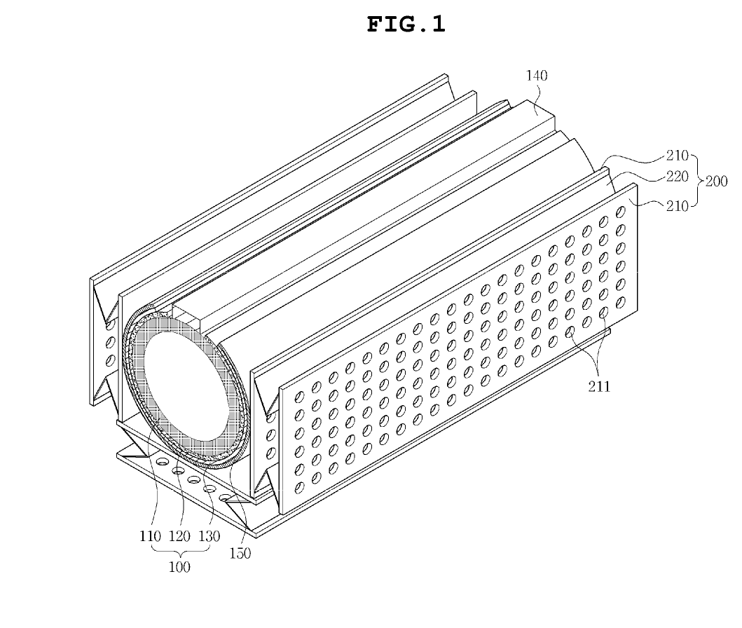

FIG. 1 is a perspective view schematically showing a solid oxide fuel cell module according to a preferred embodiment of the present invention.

A solid oxide fuel cell module according to a preferred embodiment of the present invention is configured of a unit cell 100 having a cylindrical shape and a stack support 200.

More particularly, the cylindrical unit cell 100 is configured of an internal electrode 110, an electrolyte 120, an external electrode 130, and an interconnector 140 as well known. The unit cell 100 includes a cylindrical internal electrode 110, the electrolyte 120 disposed on an outer peripheral surface of the cylindrical internal electrode 110, the external electrode 130 disposed on an outer peripheral surface of the electrolyte 120, and the interconnector 140 extended from one portion of the outer peripheral surface of the cylindrical internal electrode 110 in a length direction. This interconnector 140 is arranged to be spaced apart from the external electrode 130 by a predetermined interval simultaneously with protruding outwardly from an outer peripheral surface of the external electrode 130.

Referring to FIG. 1, in the unit cell, 100 the internal electrode 110, the electrolyte 120, and the external electrode 130 are sequentially stacked as described above. Here, the case in which the internal electrode 110 is formed as an anode and the external electrode 130 is formed as a cathode is will be described by way of example.

The anode of the cylindrical internal electrode 110 serves to support the electrolyte 120 and the cathode of the external electrode 130 stacked on the outer peripheral surface thereof The anode is formed in a cylindrical shape and receives fuel (hydrogen) from a manifold to generate negative current through an electrode reaction.

Preferably, the anode is formed by heating nickel oxide (NiO) and yttria stabilized zirconia (YSZ) to 1200 to 1300° C., wherein nickel oxide is reduced to metallic nickel by hydrogen to exhibit electron conductivity, and yttria stabilized zirconia (YSZ) exhibits ion conductivity as an oxide.

The electrolyte 120, which assists oxygen ions generated in the cathode to be transferred to the anode, is stacked on an outer peripheral surface of the anode. The electrode may be formed by performing the coating using a dry coating method such as a plasma spray method, an electrochemical deposition method, a sputtering method, an ion beam method, an ion implantation method, or the like, or a wet coating method such as a tape casting method, a spray coating method, a dip coating method, a screen printing method, a doctor blade method, or the like, and then performing the sintering at 1300 to 1500° C. The electrolyte 120 is formed on the outside of the anode using YSZ or scandium stabilized zirconia (ScSZ), gadolinia-doped ceria (GDC), La₂O₃-Doped CeO₂ (LDC), or the like, wherein since in the yttria stabilized zirconia, tetravalent zirconium ions are partially substituted with trivalent yttrium ions, one oxygen hole per two yttrium ions is generated therein, and oxygen ions move through the hole at a high temperature. Meanwhile, since the electrolyte 120 has low ion conductivity, voltage drop is less generated due to ohmic polarization. Therefore, it is preferable that the electrolyte is formed as thin as possible. If pores are generated in the electrolyte 120, since a crossover phenomenon of directly reacting fuel (hydrogen) with oxygen (air) may be generated to reduce efficiency, it needs to be noted so that a scratch is not generated.

The cathode, which receives air (oxygen) from the outside at which an oxidation atmosphere is formed to generate positive current through the electrode reaction, is stacked on the outer peripheral surface of the electrode 120 as shown in FIG. 1. The cathode may be formed by coating lanthanum strontium manganite ((La_{0.84} Sr_{0.16}) MnO₃) having high electron conductivity, or the like, using a dry coating method or a wet coating method similar to that in the electrolyte, and then sintering the coated lanthanum strontium manganite at 1200 to 1300° C. That is, air (oxygen) is converted into oxygen ion by a catalytic action of lanthanum strontium manganite and transferred to the anode through the electrolyte 120.

The interconnector 140 is directly connected to one portion of an exposed outer peripheral surface of the internal electrode 110 as shown in FIG. 1 to transfer the negative current generated in the anode to the outside of the unit cell 100 (or a current collector). In other words, since the interconnector 140 is a member for collecting current of the internal electrode 110, the interconnector 140 needs to have electric conductivity.

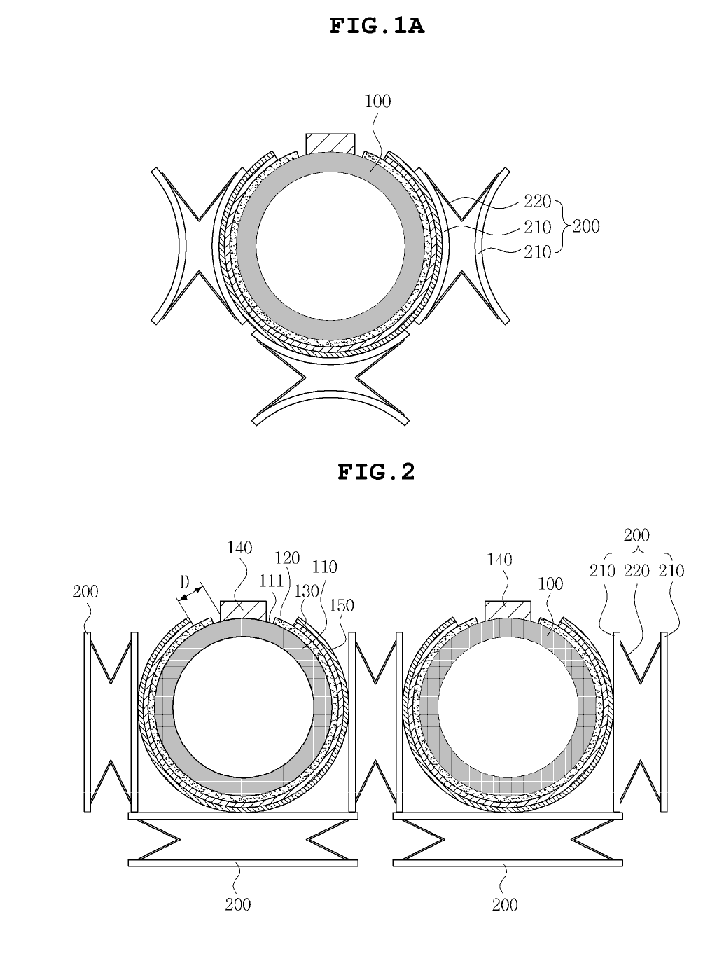

In the unit cell 100, one portion of the outer peripheral surfaces of the electrolyte 120 and the external electrode 130 are removed, thereby exposing an exposed portion 111 (See FIG. 2) of the outer peripheral surface of the internal electrode 110. Next, the interconnector 140 is disposed on the exposed portion 111. Since the interconnector 140 is in electrical communication with the internal electrode 110 as described above, in the case in which the interconnector contacts the external electrode 130, a short is generated. Therefore, the interconnector 140 and the external electrode 130 are arranged so as to be spaced apart from each other by a predetermine interval D (See FIG. 2).

Particularly, the interconnector 140 protrudes outwardly so as to be higher than the uppermost portion or the outermost portion of the external electrode 130. This is to assist in connecting the interconnector 140 to another current collecting member 200 or the current collector.

The stack support 200 serves as a buffer between unit cells adjacent to each other simultaneously with collecting electric energy generated in the cylindrical unit cell 100. To this end, in the solid oxide fuel cell module according to the preferred embodiment of the present invention, at least one, preferably, three stack supports 200 are arranged along the outer peripheral surface of the cylindrical unit cell 100.

In the present invention, the stack supports 200 are disposed in a U shape in which one portion is opened, and disposed so as to be perpendicular to each other at a lower surface, a left surface, and a right surface of the unit cell 100 except for the portion of the outer peripheral surface of the unit cell 100 on which the interconnector 140 is disposed.

The stack support 200 includes a pair of current collecting plates 210 and an elastic part 220 for spring action of the plate, as shown FIG. 1. Preferably, the stack support 200 includes the elastic part 220 between a pair of current collecting plates 210 arranged in parallel with each other, and the elastic part 220 may be fixed to the current collecting plate 210 by a welding method, or the like.

The current collecting plate 210 has a flat plate shape, and a plurality of through holes 211 are formed therein. However, the current collecting plate 210 is not limited thereto, but may be curved with the same curvature as that of the outer peripheral surface of the unit cell 100 (See FIG. 1A) to achieve an area-contact with the outer peripheral surface of the unit cell 100, such that a contact area between the unit cell 100 and the current collecting plate 210 of the stack support 200 may be maximized, thereby making it possible to significantly increase current collection efficiency.

The current collecting plate 210 may include the plurality of through holes 211 to efficiently supply gas (oxygen or hydrogen) to the external electrode 130. The elastic part 220 may be made of an SUS-based alloy bent in a V shape so as to provide elastic force. However, the elastic part 220 is not limited thereto, but may be made in various types, a coil spring shape, or the like.

Since the oxidation atmosphere is formed at the outside of the solid oxide fuel cell module according to the preferred embodiment of the present invention, in order to prevent the stack support 200 from being oxidized, it is preferable that the stack support 200 is made of the SUS-based alloy and oxidation protective coating is applied thereto.

Further, in the solid oxide fuel cell according to the preferred embodiment of the present invention, a metal mesh 150 (See FIG. 2) may be additionally arranged between the unit cell 100 and the stack support 200. The metal mesh 150 is attached to only the portion of the outer peripheral surface of the unit cell 100 using a conductive ceramic paste. More specifically, the metal mesh 150 may be attached on the outer peripheral surface of the external electrode 130 so as to prevent a contact of the interconnector 140 in advance. The metal mesh may uniformly improve an electric contact between the external electrode 130 of the unit cell 100 and the current collecting plate 210 of the stack support 200.

FIG. 2 is a view showing a state in which the solid oxide fuel cells shown in FIG. 1 are coupled in parallel with each other.

A plurality of unit cells 100 may be arranged in parallel through the stack support 200 as shown in FIG. 2 so as to collect current. Each of the unit cells 100 may be received in an internal space between the stack supports 200 disposed in the U shape and be arranged in parallel so as to be in electrical communication with the stack supports 200 at the lower surface, and left and right surfaces of the unit cell 100.

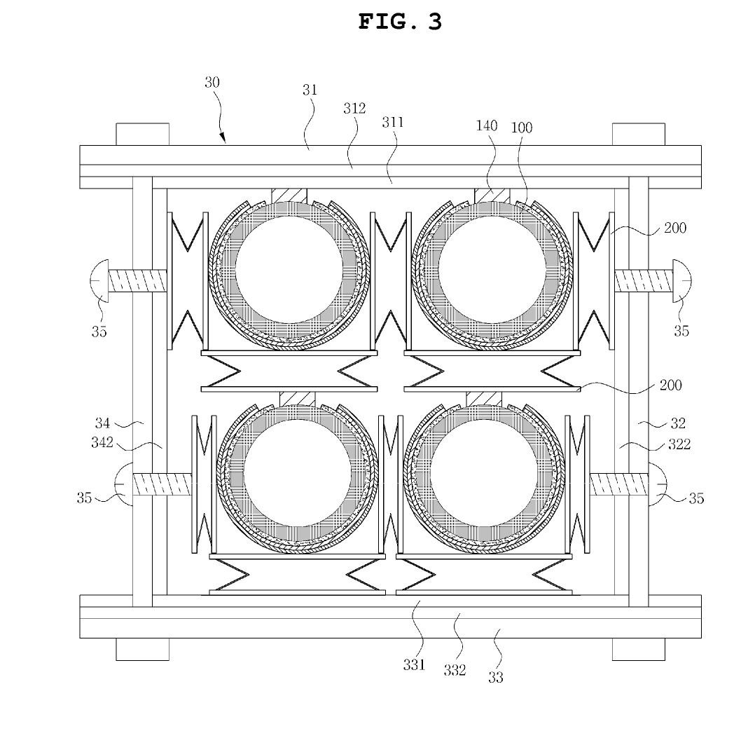

FIG. 3 is a cross-sectional view of the case in which the solid oxide fuel cell modules according to the preferred embodiment of the present invention are stacked.

Referring to FIG. 3, a stack in which the unit cells 100 are connected in series and/or with each other may be formed as shown in FIG. 3 by contacting a side of each of the stack supports 200 installed in a vertical direction with the unit cell to arrange the stack supports 200 in parallel or stacking the unit cells 100 to vertically contacting the interconnector 140 and the stack supports 200.

In the case in which the unit cell 100 and the stack support 200 are alternately stacked, three stack supports 200 arranged in the U shape may be selectively contacted with only the external electrode 130 of the unit cell 100, but the stack support 200 arranged at a different stack height may be selectively contacted with the interconnector 140 of the unit cell 100. to Therefore, the unit cells 100 received in the stack supports arranged in the U shape to be horizontally arranged are connected in parallel with each other, and the unit cells 100 received in the stack supports having different stack heights to be vertically disposed are connected in series with each other. Finally, the solid oxide fuel cell module according to the preferred embodiment of the present invention may implement the required voltage by adjusting the numbers of stack supports 200 and unit cells 100.

In the present invention, as described above, the unit cells 100 and the stack supports 200 are connected in series and/or in parallel with each other in a box shaped housing 30 to form the stack. Preferably, the housing is formed so as to maintain and support the unit cell 100 and the stack support 200 as the stack in an internal portion enclosed by support walls 31 to 34. In the housing 30, a current collector 311 is arranged beneath an upper support wall 31. In addition, in the housing 30, another current collector 313 is arranged directly above of a lower support 33.

The current collector 311 is arranged so as to selectively contact only the upper support wall 31 and the interconnector 140 of the unit cell 100 arranged at the uppermost end to collect the current generated in the internal electrode 110 (See FIG. 1) of the unit cell 100 as shown in FIG. 3.

Similarly, the current collector 331 is arranged so as to connect the vertically arranged unit cells 100 in series with each other through the lower support wall 33 and a bottom surface of the stack support 200 arranged at the lowermost end to collect the current generated in the external electrode 130 (See FIG. 1) of the unit cell 100.

Particularly, an insulation plate 312 is additionally provided in order to prevent shorts between the upper support wall 31 and the current collector 311 arranged beneath the upper support wall 31 and between the upper support wall 31 and the support walls 32 and 34. Similarly, an insulation plate 332 is additionally provided in order to prevent shorts between the lower support wall 33 and the current collector 331 arranged directly above the lower support wall 33 and between the upper support wall 33 and the support walls 32 and 34.

Selectively, insulation plates 342 and 322 are arranged at inner side surfaces of the support walls 32 and 34, respectively, thereby allowing the current collected in the stack support 200 to flow to only the current collectors 311 and 331.

As shown in FIG. 3, in the solid oxide fuel cell module according to the preferred embodiment of the present invention, the stack support 200 is fixed to the support walls 32 and 34 by various coupling method, for example, a screw fastening method, thereby making it possible to support and maintain the unit cell 100 in the stack support 200. That is, the stack support 200 to be attached to the side of the unit cell in the vertical direction is screwed and fixed to the support wall 32 or 34 of the housing 30, wherein a width of the stack supports 200 arranged at the same height may be adjusted by tightening and loosening screws 35. When the screw 35 is tightened (such as in the case of the stack support shown at a lower end portion of FIG. 3), the stack support 200 is pressed in a side direction to forcibly press the elastic part 220, such that the width of the stack support 200 (for example, a spaced distance between the pair of current collecting plates) may be reduced. Therefore, current may be stably collected in the stack with respect to external stress, and contact resistance at the time of vertically and/or horizontally collecting the current may be reduced through elastic and repellent force. Additionally, in the solid oxide fuel cell module according to the preferred embodiment of the present invention, the case in which the unit cell 100 includes the cylindrical internal electrode 110, the electrolyte 120, and the external electrode 130 sequentially stacked therein as shown in FIG. 1 and described above, the internal electrode 110 is formed as the anode, the external electrode 130 is formed as the cathode is described above by way of example.

As widely known in those skilled in the art, the unit cell may be sufficiently configured of an internal electrode formed of a cathode, an electrolyte, and an external electrode formed of an anode, and a detailed description and drawing thereof will be omitted.

As set forth above, the present invention provides the solid oxide fuel cell module in which at least one stack support capable of improving a current collection function and a support function is arranged on the outer peripheral surface of the unit cell instead of the mesh and/or foam according to the prior art.

According to the present invention, a stable contact state between the unit cell and the stack support may be maintained, and at the same time, the current collection efficiency may be improved.

According to the present invention, even though unexpected external force is applied at the time of integrating the stack, the plurality of unit cells arranged in the vertical and horizontal directions may be stably supported through gap stress acting on the elastic part of the stack support, and current collection in the stack may be performed. Therefore, serial and/or parallel connection of the unit cells may be freely constructed.

In addition, according to the present invention, at least one stack support is provided at the outside of the unit cell, such that contact resistance may be reduced.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A solid oxide fuel cell module comprising:
a plurality of unit cells including a cylindrical internal electrode, an electrolyte, and an external electrode;
stack supports including a pair of current collecting plates arranged in parallel and an elastic part changing a gap between the pair of current collecting plates.

2. The solid oxide fuel cell module as set forth in claim 1, wherein the stack support is arranged so as to be in electrical communication with the external electrode of the unit cell.

3. The solid oxide fuel cell module as set forth in claim 1, further comprising a metal mesh additionally arranged between an outer surface of the unit cell and the stack support.

4. The solid oxide fuel cell module as set forth in claim 1, wherein the current collecting plate includes a plurality of through holes.

5. The solid oxide fuel cell module as set forth in claim 1, wherein the current collecting plate has a flat plate shape.

6. The solid oxide fuel cell module as set forth in claim 1, wherein the current collecting plate is curved with the same curvature as that of an outer surface of the unit cell.

7. The solid oxide fuel cell module as set forth in claim 1, wherein the unit cell includes an exposed portion formed by partially removing the external electrode and the electrolyte to allow a portion of the internal electrode to be exposed, and further includes an interconnector provided on the exposed portion of the internal electrode.

8. The solid oxide fuel cell module as set forth in claim 7, wherein the interconnector protrudes outwardly so as to be higher than the outermost portion of the external electrode.

9. The solid oxide fuel cell module as set forth in claim 7, wherein the interconnector is spaced apart from the external electrode so as not to be in electric communication with the external electrode.

10. The solid oxide fuel cell module as set forth in claim 1, wherein the stack support is made of an SUS-based alloy, and oxidation protective coating is applied thereto.

11. The solid oxide fuel cell module as set forth in claim 1, wherein three stack supports arranged in a U shape are provided therein so as to receive the unit cell.

12. The solid oxide fuel cell module as set forth in claim 1, wherein the stack supports are arranged at both sides of the unit cell except for an exposed portion.

13. The solid oxide fuel cell module as set forth in claim 1, wherein the unit cell includes a cylindrical anode, and the electrolyte and a cathode sequentially stacked on an outer peripheral surface of the anode, the anode forming the internal electrode, and the cathode forming the external electrode.

14. The solid oxide fuel cell module as set forth in claim 1, wherein the unit cell includes a cylindrical cathode, and the electrolyte and an anode sequentially stacked on an outer peripheral surface of the cathode, the cathode forming the internal electrode and the anode forming the external electrode.

15. The solid oxide fuel cell module as set forth in claim 1, wherein it is stacked in a housing enclosed by support walls and includes a current collector provided at each of the upper and lower support walls.

16. The solid oxide fuel cell module as set forth in claim 15, wherein the housing further includes insulation plates provided at inner sides of the support walls.

17. The solid oxide fuel cell module as set forth in claim 1, wherein the stack support is arranged at a lower surface of the unit cell except for an exposed portion.
